(19) United States
(12) Patent Application Publication
(10) Pub. No.: US 2008/0311268 A1
(43) Pub. Date: Dec. 18, 2008

(54) METHOD AND FORMULATION FOR ENHANCING LIFE OF EDIBLE OIL

(75) Inventors: Lloyd Mendes, Beachwood, OH (US); Olga Fedotoff, Macedonia, OH (US); Timothy Killeen, Hudson, OH (US); Michael Krasnyansky, Bratenahl, OH (US)

Correspondence Address: RANKIN, HILL & CLARK LLP, 38210 Glenn Avenue, WILLOUGHBY, OH, 44094-7808, US

(73) Assignee: INTERNATIONAL FOOD SPECIALTIES, LLC, Beachwood, OH (US)

(21) Appl. No.: 11/939,877

(22) Filed: Nov. 14, 2007

Related U.S. Application Data
(60) Provisional application No. 60/931,655, filed on May 23, 2007.

(51) Int. Cl. C11B 5/00

(52) U.S. Cl. 426/541

(57) ABSTRACT

Methods and products for enhancing the life of edible oil such as cooking or frying oil are disclosed. In one aspect, a time release capsule with one or more antioxidants is described. In another aspect, a single-dose solid product is described that is simple and convenient to administer. In yet another aspect, a particular oil replenishment method is provided that achieves a relatively constant concentration of antioxidant.

### CROSS REFERENCES TO RELATED APPLICATIONS

The present application claims priority upon U.S. provisional application Ser. No. 60/931,655, filed on May 23, 2007, herein incorporated by reference.

### FIELD

The present invention relates to methods and various formulations for improving the properties of edible oil during cooking such as in frying, and particularly for extending the useful life of frying oil.

Specifically, the invention relates to reducing the extent of oxidation and thus the rancidity of edible cooking oils and/or fats, and of the products cooked with such oils or fats. The invention also relates to an improved delivery system and method for effectively and simply delivering an effective amount of an antioxidant to an edible oil and/or fat material such as may be used in frying of various foods.

### BACKGROUND

With the advent of fast food chains and the popularity of various products prepared by deep frying, attention has focused on the well recognized problem of inhibiting the oxidation and rancidity of the cooking medium used in frying and of the products cooked thereby.

Typically, these operations involve the use of commercial sized deep frying systems which may vary in size from about 35 to 100 pounds of cooking medium, e.g., between about 16 kg to about 45 kg, for example. Usually, the cooking systems include circulation and clean-up systems which operate to recirculate the hot cooking fluid during use. Typical such operations are the so-called fast food operations in which potato or onion products or fish or poultry products are deep fried.

Other commercial operations include potato chip or other chip type manufacturing in which potato or corn type products are deep fried.

In addition to the problem of oxidation of the cooking medium, there is also the related problem of the rancidity of the cooked product since a portion of the cooking medium is carried out with and remains with the cooked product.

Typical such products are potato chips and corn chip type products and the like. In such products, the focus is on preventing oxidation and rancidity of the cooked product, thus extending the shelf life and the quality of the product, in which case the stability of the cooking medium is a lesser, though important consideration.

Other operations in which deep fat frying is carried out, include those in schools and dormitory residences. But there, the cooking period is relatively short as compared to continuous or near-continuous commercial operations.

Nonetheless, in each type of cooking operation the problems related to oxidation and rancidity are essentially the same, albeit perhaps more acute in the commercial operations.

In deep frying, whether on a commercial long continuous period basis or for a relatively short period basis, as for example in a school lunch program, the cooking oil is subjected to high temperatures, and is exposed to atmospheric oxygen and water. Water is frequently carried into the cooking medium with the product being cooked.

Depending upon the type of cooking oil or combination of oils and/or fats used, these conditions may result in oxidation, hydrolysis and polymerization of the cooking medium. Typical visible signs of such effects are darkening of the oil, increase in viscosity, lowered smoke point, and rancidity.

Usually the cooking medium is an oil or fat or mixture of oils and fats, of an edible variety and of a vegetable or animal origin, and may exhibit a tendency to become rancid due to oxidation thereof. This oxidation can be accelerated due to the relatively high temperatures used during cooking, especially on a commercial scale. Typical cooking temperatures for such cooking oils and/or fats, periodically referred to herein as the “cooking medium” for convenience, may be in the range of from about 350° F. to about 400° F., e.g. in the range of about 175° C. to 200° C. This thermal and/or oxidative deterioration of the cooking medium has been dealt with in several different ways.

In about the mid 1970's, it was discovered that thermal and oxidative decay of the cooking medium could be retarded by the use of antioxidants. Various such materials are known in the art and described in any number of prior patents, see for example, U.S. Pat. Nos. 3,883,673; 3,852,502; 3,867,445; 3,873,466; 3,969,383; 3,955,005; 4,022,822; 4,038,434; 4,044,160; 4,055,617; and 4,115,597 to mention only a few.

Some cooking oils or fats have natural antioxidants present, for example, citrus oils contain Vitamin A. Once the Vitamin A loses its potency, the oil becomes bitter. In the case of lard or tallow, for example, wheat germ has been used to prevent oxidation due to the presence of natural antioxidants in the wheat germ, typically tocopherol type compounds. In other instances, the oil and/or fat, particularly refined vegetable oils have been hydrogenated to reduce oxidation. Hydrogenation, however, is a comparatively expensive process resulting in higher prices for hydrogenated refined vegetable oils.

One simple but comparatively expensive solution to the problem of controlling oxidation has been to replace the cooking medium at the appropriate time when it was determined that the cooking medium was no longer usable.

Unfortunately, due to the expense of replacement, there was a tendency of the users to continue the use of the deteriorated cooking medium beyond its useful life, with the result that the quality of the cooked products varied in relation to the age of the cooking medium. In those instances where it is desired to maintain the quality of the cooked product from day to day and from one location to the next, as for example in fast food or convenience food outlets, this approach was not entirely satisfactory.

U.S. Pat. No. 4,115,597 describes a system which includes a pump and filter system for recirculating the oil, a makeup oil reservoir and an antioxidant addition system in which the antioxidant is an aqueous emulsion. The continuous addition of the antioxidant is said to increase the life of the oil up to 500%. However, this system was likely too sophisticated and costly to implement on a wide scale or at a commercial level.

Artisans have also investigated the antioxidants. Historically, propyl gallate (the n-propyl ester of 3,4,5-tri-hydroxybenzoic acid) was used as an antioxidant, but it suffered the disadvantage of being rapidly depleted.

More recently, materials such as tertiary butylhydroxyquinone (TBHQ), butylated hydroxyanisole, which is a mixture of the 2- and 3-isomers of tert-butyl-4-hydroxyanisole (BHA), and butylated hydroxytoluene (BHT) have been used as antioxidants. These materials are available in food-grade quality from Eastman Chemical Products, Inc. under the trademark TENOX, and are supplied in a variety of forms and formulations. The Food and Drug Administration (FDA) permits the use of BHA, BHT propyl gallate, and TBHQ, singly or (with one exception) in combination of two or more in a maximum concentration of 0.02% of the weight of oil or fat (i.e. 200 ppm), see 21 CFR 182.3169, 182.3173 184.1660, and 172.185. The one exception is that TBHQ is permitted for use only with BHA and BHT, and may not be used with propyl gallate. In some of these formulations, other materials are present, for example, citric acid used as a chelating agent or synergist, and solvents or carriers such as vegetable oil, propylene glycol or glyceryl mono-oleate, for example.

It is well recognized that antioxidants of the type described are not preservatives and do not function as such.

Preservatives are generally materials which inhibit bacterial activity such as mold growth. Typical preservative materials are calcium proprionate, sorbic acid, potassium sorbate, parabens, acetic acid and proprionic acid, to mention a few. Antioxidants do not function as preservatives and the latter do not function as antioxidants. To date the practice has been to add the antioxidant to the cooking medium through the addition of makeup oil containing an approved amount of an approved antioxidant.

Normally, the oil contains antioxidant to inhibit oxidation prior to use and during use, and the addition of new oil containing antioxidant to make up for that lost in the cooking medium introduces antioxidant into the cooking medium. The difficulty, however, is that the antioxidant is rapidly depleted in the first eight to nine hours of continuous frying and the addition of makeup oil never provides sufficient antioxidant, within the range permitted, for effective inhibition of oxidation.

Another method to inhibit oxidation is the direct addition of the antioxidant to the cooking oil which has been heated to between 145 and 175° F. (63 to 80° C.), while the cooking oil is agitated to cause motion in the oil. After addition, agitation is continued for about 20 minutes.

Related to this strategy, the antioxidant or a concentrate of the antioxidant is proportioned into the cooking medium through a pipeline, using a stainless steel proportioning pump. In this procedure all of the piping through which the antioxidant flows should be of stainless steel or glass. Although satisfactory in certain respects, uncertainties remain since an excess addition of antioxidant can raise the overall concentration of antioxidant in the system to a level that exceeds limits imposed by the FDA. And, an insufficient addition can lead to poor qualities of the resulting oil system.

Antioxidants are typically available in liquid form. Although generally easier to disperse within a liquid oil system; storage, handling, and administering of liquid antioxidants typically increases costs as liquid handling and injection systems are frequently required. Accordingly, artisans have investigated solid forms for antioxidants.

It is known that it is difficult to solidify or pelletize antioxidant materials, especially TBHQ, due to the need of excipients which do not have good oil solubility. The components needed to pelletize the antioxidant materials tend to have qualities adverse to the qualities needed in the cooking medium. U.S. Pat. No. 4,473,620, however, discloses a free flowing BHA material in which an edible polymer is used to form a film around melted BHA in droplet form thus forming a particulate BHA product in which the particles are polymer coated to provide a free flowing quality to the BHA.

For over 30 years, TBHQ has proved to be a most effective antioxidant for deep-frying. And, the addition of an antioxidant after the cooking process has proven successful on a commercial scale in increasing the storage life of different products. Quality cooking oil today contains TBHQ, which provides good carry through in frying oils, does not form colored complexes with metals and can achieve excellent oxidative stability with levels of TBHQ at 100 to 200 ppm.

Although advances have been made in this field, a significant problem with any antioxidant and particularly TBHQ, is rapid decrease in concentration. Investigations by the present inventors reveal that a ten-fold concentration decrease often occurs during the first 24 hours of heating at 335° F. without frying. Such rapid depletion of any antioxidants and TBHQ is particularly undesirable. Even greater concentration reductions occur upon frying.

Typically, current practice is to add the antioxidant to the frying oil through the addition of make up oil, containing 100 ppm of antioxidant. However, due to the end user frequently adding make up oil, and the rapid decreasing of TBHQ concentration in original oil during the first 10 hours of frying, it is difficult to achieve a relatively constant concentration of antioxidant in the overall system. Furthermore, make up oil frequently does not provide sufficient concentration of antioxidant for effective resistance to rancidity.

Therefore, it is apparent that a more efficient and comparatively simple method for introducing a known and effective amount of a permitted antioxidant into a cooking medium is desired, especially one which will not adversely affect the cooking oil. The use of materials which are incompatible with the oil or insoluble in the oil generally should not be used since there is a danger that significant amounts of such materials will be carried out with the product being cooked.

Thus, one of the principal objectives of the present invention is to provide a relatively simple but effective system to provide a controlled and known amount of an antioxidant which is in a form that does not adversely affect the cooking medium to which it is added.

Although a wide array of strategies have previously been proposed for providing a known amount of an approved antioxidant material into a cooking medium, many of the previously proposed techniques have required complex metering or measuring systems, which are costly to implement and maintain. In addition, such systems are typically sophisticated and beyond the level of expertise of a typical employee working in the fast-food field. Accordingly, it would be desirable to provide a simple method for introducing an antioxidant into a cooking medium.

Therefore, and more specifically, an object of the present invention is to provide a known and effective amount of an approved food-grade antioxidant material having an effective active amount of antioxidant qualities for use as a single dose component for addition to a cooking medium of a specified amount for the inhibition of oxidation.

Still a further object of the present invention is the provision of a relatively simple, but effective method of delivering an effective and controlled amount of an antioxidant as an additive, and particularly in a capsule form, to a cooking medium.

In view of the above-described problems, it is also an objective of the present invention to provide a method which introduces a composition comprising an antioxidant such as TBHQ incorporated in capsule form to cooking oil at a particular time when it is most effective.

Yet another problem, although apparently not recognized in the art, is that undesirable fluctuations in the concentration of antioxidants in the cooking medium, frequently occur, and the extent of these fluctuations was not previously appreciated nor were the reasons therefor, entirely understood. As explained in the description of the invention herein, such fluctuations promote and in certain instances, result in increased oxidation and/or rancidity of the cooking medium, and frequently, an unpleasant taste associated with the food products cooked or deep fried therein.

Therefore, it is also an object of the present invention to provide a new technique for administering one or more antioxidants to a cooking medium which results in a relatively constant concentration of the antioxidant(s) in the cooking medium, and thereby avoid the previously noted concentration fluctuations.

### BRIEF DESCRIPTION

In one aspect, the present invention provides a tablet adapted to provide a controlled release of at least one antioxidant into a liquid oil-based system upon introduction of the tablet in the system. The tablet comprises an effective amount of at least one antioxidant selected from the group consisting of (I) tertiary butylhydroquinone, (II) propyl gallate, (III) butylated hydroxyanisole, (IV) butylated hydroxytoulene, and combinations of (I)-(IV). The tablet also comprises a coating disposed about the at least one antioxidant. The coating is exposed and in contact with the oil-based system upon introduction of the tablet in the system. The coating provides a controlled release of the at least one antioxidant such that all of the amount of the antioxidant is released over a time period of from about 0.5 hours to about 8 hours.

In another aspect, the present invention provides a method for introducing at least one antioxidant into a liquid oil-based system. The method comprises providing an oil-based system comprising at least one antioxidant in a desired concentration. The method also comprises forming a minority proportion and a majority proportion of the system, in which the minority proportion constitutes from about 10% to about 20% of the total volume of the oil-based system. The method further comprises replacing the minority proportion of the oil-based system with a new minority proportion that includes an equal amount of oil as the replaced minority proportion and the at least one antioxidant in the desired concentration. After a time period of from about 4 to about 36 hours, these steps are repeated.

### BRIEF DESCRIPTION OF THE DRAWINGS

FIG. 1 is a graph illustrating typical concentration fluctuations of TBHQ in two systems of cooking mediums over a time period of 65 hours.

FIG. 2 is a graph comparing oil stability index (OSI) values for three sets of cooking oil samples treated in accordance with the present invention.

FIG. 3 is a graph of free fatty acids (FFA) percentages for three sets of cooking oil samples treated in accordance with the present invention.

FIG. 4 is a graph illustrating the superior performance and reduced levels of active oxygen in an oil sample treated in accordance with the present invention.

FIG. 5 is a graph illustrating TBHQ concentration levels resulting from a preferred embodiment oil replenishment cycle in accordance with the present invention.

### DETAILED DESCRIPTION

In accordance with the present invention, various preferred embodiment solid dosage products comprising one or more antioxidant(s) and which provide a controlled release of the antioxidant(s), are provided. In a preferred aspect, these products provide a time release of the antioxidant(s). The present invention also provides methods for selectively administering one or more antioxidants into a cooking medium. In a preferred aspect, the invention provides a batch-wise oil replenishment technique that results in a surprisingly constant concentration of antioxidant(s) in the cooking medium.

The term “tablet” as used herein generally refers to the various preferred embodiment solid dosage products in accordance with the present invention. The term tablet also encompasses products comprising liquid or semi-liquid, i.e. flowable, interior regions of ingredient however, that are contained within a generally solid and self-supporting wall or coating. The wall or coating in turn constitutes the exterior surface of the tablet, or may in some instances receive one or more additional coatings.

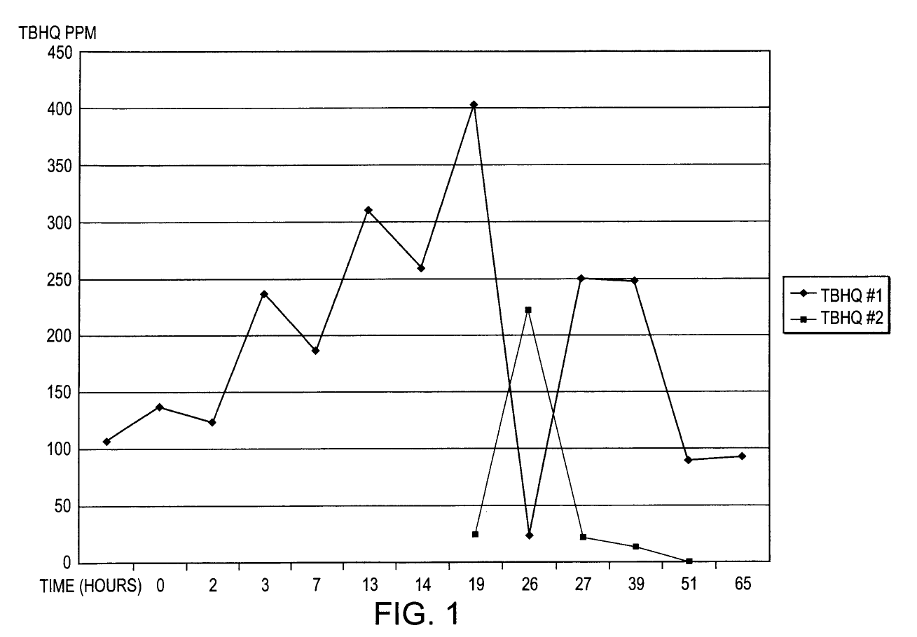

The amount or concentration of the antioxidant(s) will vary in a system such as utilized in a commercial cooking establishment. As previously noted, this is primarily due to depletion of the antioxidants, such as from decomposition and carry out in food products that are immersed and then withdrawn from the cooking medium. Changes in amounts or concentrations of antioxidants can also occur as a result of replacing oil from the system or adding oil to the system. FIG. 1 illustrates representative fluctuations in concentrations of TBHQ in two respective cooking medium systems. As shown in the system designated as “TBHQ #1,” TBHQ concentrations can progress through a series of increases and decreases as additional amounts of TBHQ are added to the system every several hours. The system TBHQ#1 used oil initially containing TBHQ at a concentration of about 100 ppm. At regular intervals, make up oil was added containing additional amounts of TBHQ. The resulting concentration progressively increased until the level of TBHQ was at alarmingly high levels, i.e. above 400 ppm. Upon changing or finishing of the oil, beginning at 19 hours, the concentration of TBHQ plummeted. Upon reintroduction of new oil at 26 hours, the concentration then rose to about 250 ppm, after which depletion of TBHQ caused the overall concentration of TBHQ to decrease. The system designated as “TBHQ #2” illustrates similar fluctuations in concentration of TBHQ. In this system, oil not containing any TBHQ was initially used. TBHQ was added to the system, such as at hour 19, until it reached a maximum concentration of about 225 ppm. After that, the concentration of TBHQ plummeted. It can be seen that fluctuations in the concentration of TBHQ readily occur over time. Such widely changing concentration levels promote undesirable characteristics in the cooking medium and products cooked therein.

The preferred embodiment solid dosage products of the present invention provide a controlled release of antioxidant(s) into the cooking medium. Preferably, the controlled release is achieved by the use of (i) one or more coatings utilized on the solid dosage products or portion(s) of the products, (ii) microencapsulation techniques to produce small encapsulated particles comprising the antioxidants, which in turn, are incorporated into the solid dosage products, and (iii) combinations of (i) and (ii). Most preferably, the controlled release feature is utilized to impart a time release characteristic to the solid dosage products.

The coatings that constitute the outer surface and/or outer body of the solid dosage products may comprise any of the well known and commercially available materials typically used. Representative examples of such materials include, but are not limited to, gelatin, gelatin-like materials, various stearates including glycerol monostearate and various glycerides and diglycerides such as for instance, monodiglycerides.

The one or more antioxidants may also be formed into relatively small capsules or particles, such as microcapsules, which in turn are coated with a secondary coating composition. Representative secondary coating compositions may be the same as the composition of the outer surface of the solid dosage products, or may be different. Materials used in the secondary coatings may include materials used in the previously noted outer coating of the product.

Micro-encapsulation is a process in which tiny particles or droplets are surrounded by a coating to produce small capsules with many useful properties. In a relatively simplistic form, a microcapsule is a small sphere with a uniform wall around it. The material inside the microcapsule is referred to as the core, internal phase, or fill, whereas the wall is sometimes called a shell, coating, or membrane. Most microcapsules have diameters between a few micrometers and a few millimeters.

Many microcapsules however bear little resemblance to these simple spheres. The core may be a crystal, a jagged adsorbent particle, an emulsion, a suspension of solids, or a suspension of smaller microcapsules. The microcapsule even may have multiple walls.

A wide array of techniques can be used to form microcapsules containing one or more antioxidants. For example, representative methods include, but are not limited to pan coating, air suspension coating, centrifugal extrusion, vibrational nozzles, spray-drying, interfacial polymerization, in-situ polymerization, and matrix polymerization.

In accordance with the present invention, the solid dosage products provide a controlled release, preferably over an extended period of time, once the product is introduced into the cooking medium. Preferably, the release of the active ingredients, i.e. the antioxidant(s), occurs over a period of time, such as from about 0.1 to about 10 hours, more preferably from about 0.5 to about 8 hours, more preferably from about 1 to about 6 hours, and most preferably from about 1.5 to about 3 hours. The extent or degree of release of the antioxidant(s) over the release period is preferably relatively uniform. That is, the rate of release is preferably relatively constant. However, the present invention includes embodiments in which the release is not uniform, such as may be desired in applications in which the product is initially introduced into a new cooking medium, and particularly one that is free of any antioxidants. That is the rate of release may vary, such as from 10% to 500%, more preferably, from 20% to 400%, and more preferably from 50% to 200%, with regard to rates of release as compared to one another, during the release period.

Before turning attention to the preferred embodiment solid dosage products of the invention, it is instructive to note preferred antioxidant(s) for incorporation therein. The present invention may utilize any food-grade acceptable antioxidant, and particularly, those accepted for use in oil-based systems. Representative examples of such preferred antioxidants include, but are not limited to one or more of the following:

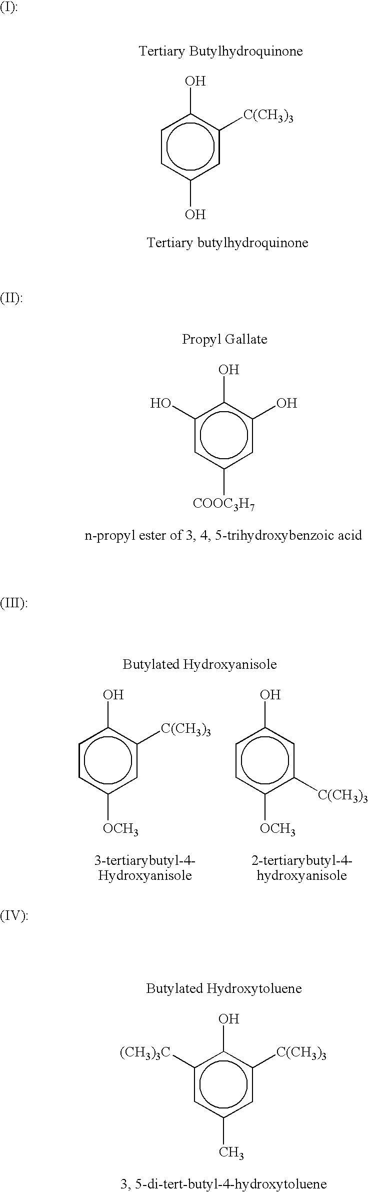

As previously noted, TENOX, containing TBHQ, is commercially available from Eastman Chemical. Each of the preferred additives (I)-(IV) in food grade form is also commercially available from a wide array of suppliers.

In addition, the preferred embodiment solid dosage products may comprise citrus oils, citric acid, Vitamin A, Vitamin K, and the like.

In addition to the antioxidant, ascorbyl palmitate is found to be particularly useful in improving the antioxidant performance of the antioxidants noted above. The ascorbyl palmitate is most preferably added to the solid dosage products in an amount of about 0.1 to about 1.0% of the product by weight.

The preferred embodiment solid dosage products typically also comprise one or more fillers, diluents, and/or excipients.

Although the preferred embodiment products are described herein as solid, it will be appreciated that one or more ingredients of the products may be in a liquid form. For example, certain commercially available antioxidants are supplied in a liquid form. Conventional practices can be used to incorporate the liquid component(s) into the solid dosage products.

As noted, the coatings of the preferred embodiment solid dosage products are utilized to provide a controlled rate of release of the antioxidant(s) into the cooking medium. The composition and method of forming of the coating are selected such that the active contents of the product, i.e. the antioxidant(s), are released at a particular rate or within a desired range of release rates. Generally, the coatings are formulated to provide the desired rate of release at a particular temperature, which is typically the operating temperature of the oil, e.g. about 350° F. to about 400° F. Coatings can comprise a wide array of ingredients, however, the following coating composition is noted:

TABLE 1
Coating Composition

| | | More | Most |
|---|---|---|---|
| | Preferred | Preferred | Preferred |
| Ingredient | Percentage | Percentage | Percentage |
| Soybean Oil | 20-50 | 30-40 | 36.5 |
| Corn Oil | 20-50 | 30-40 | 36.5 |
| Citric Acid | 0-10 | 1-5 | 2.6 |
| Monodiglyceride | 10-40 | 20-30 | 24.4 |
| TOTAL | 100 | 100 | 100 |

Specifically, the present invention provides a uniquely sized and formulated tablet that comprises a combination of active ingredients such as TBHQ and the commercially available TENOX. Table 2 set forth below, lists preferred and more preferred compositions for the preferred embodiment tablet comprising a combination of active ingredients.

TABLE 2
Tablets Comprising Combination of Active Ingredients

| | | More |
|---|---|---|
| | Preferred | Preferred |
| Ingredient | Percentage | Percentage |
| TBHQ (powder) | 40-60 | 45-55 |
| TENOX (liquid) | 25-45 | 30-40 |
| Other | 0-35 | 5-25 |
| TOTAL | 100 | 100 |

A most preferred formulation for such a tablet is set forth below in Table 3. This preferred tablet is 7.25 g and can be used in dosages of 1 tablet per 25 liter vat, to comply with the 200 ppm maximum concentration.

TABLE 3
Most Preferred Active Ingredient Combination Tablet

| Ingredient | Grams | % Total |
|---|---|---|
| TBHQ (powder) | 3.75 | 51.7 |
| TENOX (liquid) | 2.5 | 34.5 |
| Other | 1.0 | 13.8 |
| TOTAL | 7.25 | 100 |
| Citric Acid | note 1 | |
| Vitamin K | note 1 | |

Note 1:
One or both of the citric acid and Vitamin K are optional and can be present in trace amounts in the preferred embodiment solid dosage products.

The solid dosage products or tablets as set forth in Tables 2 and 3 can be formed in a variety of different methods. Preferably, the TBHQ in powder form, citric acid and Vitamin K (if used) are added to the liquid TENOX. Heating may be utilized to promote mixing. The resulting mixture is poured into a ceramic mold and allowed to solidify. The material is solid at room temperature. The tablet as described weighs 7.25 grams.

Another preferred embodiment product in accordance with the present invention is a solid dosage product utilizing a single active ingredient such as in the form of a tablet or wafer. The preferred product has the following composition as set forth in Table 4.

TABLE 4
Another Preferred Solid Dosage Product

| | | More | Most |
|---|---|---|---|
| | Preferred | Preferred | Preferred |
| Ingredient | Percentage | Percentage | Percentage |
| TBHQ | 15-45 | 25-35 | 30.3 |
| Glycerol Monostearate | 85-55 | 75-65 | 69.7 |
| (GMS) | | | |

The preferred solid dosage products, such as those described in Table 4, are preferably formed as follows. Glycerol monostearate is heated to 140° C. The TBHQ is added with mixing and allowed to heat and mix with the glycerol monostearate for 30 minutes. Lab batches are typically within the range of 10 to 200 gram batches, however, smaller or larger batches are contemplated. Generally, below 140° C. the TBHQ does not readily dissolve into the glycerol monostearate. Also heating above 140° C. may cause breakdown or decomposition of TBHQ.

The mixture is then poured into a ceramic mold and allowed to cool. The material is solid at room temperature. The solid dosage product, which for example may be in the form of a tablet or wafer, preferably weighs 15 grams. A 7 gram wafer is also contemplated.

Final packaging for both of the previously described solid dosage products is preferably air tight, plastic or metallic foil.

Another preferred embodiment solid dosage product is in the form of a tablet comprising an interior portion comprising TBHQ glycerol monostearate and an outer coating of glycerol monostearate.

The oil(s) used in the cooking mediums referenced herein can comprise a wide variety of oils. For example, soybean oil as used in shortening, margarine and cooking oil is highly unsaturated, containing a high amount of linoleic acid, leading to what is called “flavor reversion”. This attribute of this oil may be countered by partial hydrogenation or the addition of a chelating agent such as citric acid. Nonetheless, antioxidants as described herein serve to operate to stabilize the oil against oxidation.

Palm oil is actually a fat in that it is a semi-solid at room temperature. The enzymes in the pulp of the source fruit lead to hydrolytic rancidity which is generally responsive to antioxidants. Heat treating of the pulp tends to inactivate the problem enzymes. This particular product is a highly saturated material. Stability of this oil may be improved by the use of THBQ. This oil is used in margarine, shortening and frying oil.

Sunflower seed oil is used as a cooking oil. It is composed of generally 85% or more of unsaturated fatty acids and responds well to antioxidants.

In contrast, cottonseed oil, also used as a cooking oil, has a relatively high oxidative stability, but exhibits enhanced oxidative stability when antioxidants are added.

Cottonseed oil is principally a lauric acid fat with a sharp melting point and a somewhat bland flavor. It is highly resistant to oxidation and is normally not used as a cooking oil. It is susceptible to hydrolytic rancidity which gives a soapy flavor to the oil or to the food cooked in rancid cottonseed oil. While antioxidants will not inhibit hydrolytic rancidity, they do increase inhibition of oxidative rancidity.

Peanut oil is used as a cooking oil and has a high degree of unsaturation in comparison to other vegetable oils. Stability against oxidation is enhanced by the use of antioxidants.

Rapeseed oil has a high content of long chain fatty acids and has a high viscosity compared to other vegetable oils. Rapeseed oils are available under the trademark CANOLA. It is usually used in shortening and cooking oils. Like soybean oil, it has a comparatively high content of linoleic acid and is susceptible to flavor reversion. Nonetheless, antioxidants are effective in inhibiting oxidation and racidity due to oxidation.

Olive oil is used principally for cooking and as a salad oil. It has a low fatty acid content and somewhat greater oxidative stability than other vegetable oils. It is high in flavor and odor and these qualities of this oil tend to mask rancidity. This oil responds well to antioxidants and chelating agents.

Palm kern oil in large measure resembles coconut oil in that it is highly resistant to oxidation since it is composed largely of saturated fatty acids. This oil responds well, as does coconut oil, to antioxidants.

Sesame seed oil is used as a cooking oil and is rather unusual from an oxidation point of view. This oil contains a number of phenolic compounds, typical of the antioxidants thus far discussed, such as sasamine and semolina, which operate as antioxidants. This particular oil has high resistance to oxidation but is generally not used in large commercial operations. It is sometimes used in the preparation of certain foods prepared by deep fat frying in which the flavor of the food is consistent with the oil used. Antioxidants may not be needed with this particular oil.

Corn oil is used principally as a cooking oil. It is usually partially hydrogenated, but nonetheless is prone to oxidation and responds well to antioxidants.

Safflower seed oil is the most highly unsaturated edible oil known. It responds well to the use of antioxidants.

In addition to the above, there are a number of edible animal fats, such as lard and poultry fats which may be used as cooking oil or as a component of cooking oil. It is recognized, however, that the bulk of the oils used for deep fat frying are vegetable oils such as soybean oil, sunflower oil and palm oil, all of which may have their useful life extended through the use of antioxidants.

In accordance with the present invention, a preferred embodiment oil replenishment technique is provided. In this technique, a minority proportion of the oil is replaced with new oil comprising a particular concentration of active ingredients so as to produce a particular concentration of TBHQ. The remaining majority proportion of the oil is carried over to the next time at which another minority proportion of oil is replaced. That next minority proportion of oil also comprises TBHQ. This series of operations is repeated. Eventually, the resulting concentration of TBHQ approaches a relatively constant level. This is a surprising discovery as prior art practices of periodically adding TBHQ to oil systems, or make-up oil comprising TBHQ to oil systems, resulted in such systems having highly fluctuating concentrations of TBHQ, as depicted in FIG. 1.

More particularly, a preferred embodiment replenishment method in accordance with the present invention, is that the minority proportion be in an amount of from about 10% to about 20%, more preferably from about 12% to about 18%, and most preferably about 15% by volume, based upon the total volume of the oil system. The minority proportion comprises TBHQ in a desired concentration, such as for example, from about 200 ppm to about 50 ppm. Although the amount of TBHQ in the oil system as whole generally decreases as a function of oil use, e.g. such as from decomposition of the TBHQ and carry-out from the oil system as food products retaining oil and TBHQ are removed from the oil, as minority proportions of oil are continually added, a final steady-state TBHQ concentration level is reached in the oil system as a whole. Generally, this steady-state value is about 60% to about 70% of the initial desired concentration of TBHQ in the oil system. And, perhaps of greater significance, is that this steady state value is reached relatively quickly, such as in only about 4 to 6 cycle iterations. It will be appreciated that although TBHQ is noted as the antioxidant in these preferred methods, any of the antioxidants described herein can be used or combinations of such antioxidants.

Generally, the minority proportion of the oil is replaced with an equal amount of oil. Although it is also appreciated that the volume of the replacement oil may be increased to accommodate loss of oil from the system resulting from carry out with food cooked therein. The oil that is used to replace the minority proportion is preferably of the same type. For example, if the minority proportion contains soybean oil, then it is preferred that soybean oil is used as the oil in the new minority proportion.

The time period between repeating this series of operations, e.g. between replacements of minority proportions, can be relatively short, such as on the order of only several minutes, or can in certain instances, be as long as several days. However, it is generally preferred that the time period between replacement of minority proportions be from about 1 to about 48 hours, more preferably from about 4 to about 36 hours, and more preferably from about 6 to about 24 hours, for a typical fast food deep frying application.

### Testing Results

A series of investigations were undertaken to review and assess the efficacy and usefulness of the preferred embodiment products and methods.

### EXAMPLE I

Laboratory testing was performed using a preferred formulation in accordance with the present invention for five widely used vegetable oil cooking mediums. These cooking mediums were: (i) soybean, (ii) palm oil oleic, (iii) sunflower, (iv) canola and corn, and (v) a private label oil containing TBHQ, citric acid and other additives. A preferred embodiment time release capsule in accordance with the present invention was provided, comprising as a coating, 15% soybean oil, 15% corn oil, 1% citric acid and 10% monodiglyceride and active ingredients TBHQ and TENOX 20 retained within a collection of time release microcapsules. The capsules were formulated to exhibit specific release times of the active ingredients for each oil.

The five widely used oils and private label oil were divided into two sets of samples: pure oil, and oil with antioxidant.

For pure oils, the target antioxidant concentration was 150 ppm. For oils with an antioxidant, the target antioxidant concentration was 100 ppm.

Specifically, for pure oils (no antioxidants), a capsule designed to provide 150 ppm of active ingredients, was introduced to a cooking system containing 35-45 pounds of oil at the beginning of a working cycle and every 8 hours of frying cycle.

For oils with antioxidant, a capsule designed to provide a 100 ppm concentration of active ingredients, was introduced to the 35-45 pounds of oil after 5 hours from beginning of a working cycle and then every 12 hours of frying cycle.

In accordance with the testing results described in detail herein, it has been surprisingly discovered that antioxidants are more effective when antioxidant concentration in a cooking medium or working oil is not less than 20 ppm. If such concentration is less than 20 ppm, all major quality control parameters of oil such as free fatty acid (FFA), smoke point, oil stability index (OSI) and other measures, deteriorated very rapidly, and recovery with make up oil and extra antioxidants was not effective or as effective as such should be.

Several tests and blind testing were used in evaluating the present invention. Blind testing confirmed that food fried utilizing the preferred embodiment products and methods exhibited the same taste, appearance, texture and aftertaste, as conventional frying methods.

### EXAMPLE II

In this analysis, various oil quality parameters were measured.

Sysco Soybean Reliance oil (45 lb) was used in Frymaster fryers. Make up oil was added as necessary. A preferred embodiment antioxidant composition was introduced to the oil approximately every 24 hour period to achieve 150 ppm TBHQ. Deep fry temperature setting was 330° F. Temperature was maintained for 11 to 13 hours each frying day. An external thermometer confirmed that fryers operated correctly. Fryers were off at all other times. Oil samples were taken approximately every 4 to 5 hours, 2 to 3 times a day.

The following data associated with this cooking medium and system were obtained: a) TBHQ concentration, b) oxidative stability index (OSI), and c) free fatty acid (FFA). OSI is measured by passing air through a sample held at constant temperature. After the air passes through the sample, it is bubbled through a reservoir of deionized water. Volatile acids produced by lipid oxidation are dissolved in the water thereby increasing its conductivity. Conductivity of the water is monitored continuously and the OSI value is defined as the hours required for the rate of conductivity change to reach a predetermined value. Multiple samples can be tested simultaneously and software controls instrument parameters and data collection. The method has been collaboratively studied and accepted by the American Oil Chemists' Society (AOCS).

Free acids in a fat (or fat extracted from a sample) can be determined by titration. The free fatty acid (FFA) value is then expressed as percentage of a fatty acid common to the product being tested. Frequently, values are expressed as percentage oleic acid for tallows or soybean oils. For coconut oils or other oils that contain high levels of shorter chain fatty acids, FFA may be expressed as percentage lauric acid. FFA is an indication of hydrolytic rancidity, but other lipid oxidation processes can also produce acids. It may also be useful to know the composition of the free fatty acids present in a sample to identify their source and understand the cause of their formation. Extracts of samples can be analyzed for free fatty acid profiles when this information is required.

Test Results—18 samples including blank oil samples were sent for testing to an FDA approved food laboratory, Barrow-Agee Laboratories of Memphis, Tenn. Five samples were taken from a second control fryer where no preferred embodiment composition was added.

Untreated and unused original Soybean Sysco Reliance oil contains approximately 100 ppm of TBHQ, with an OSI of 16.7 hours, and FFA of 0.023%. Control oil (free of the preferred embodiment composition) results show that in approximately 84 working hours, TBHQ concentrations decreased less than 1% and OSI was 7.6 hours, and FFA was 1.260%. The same period of working hours oil with 89 ppm TBHQ, exhibited OSI of 22.85 hours, and FFA of 0.871%.

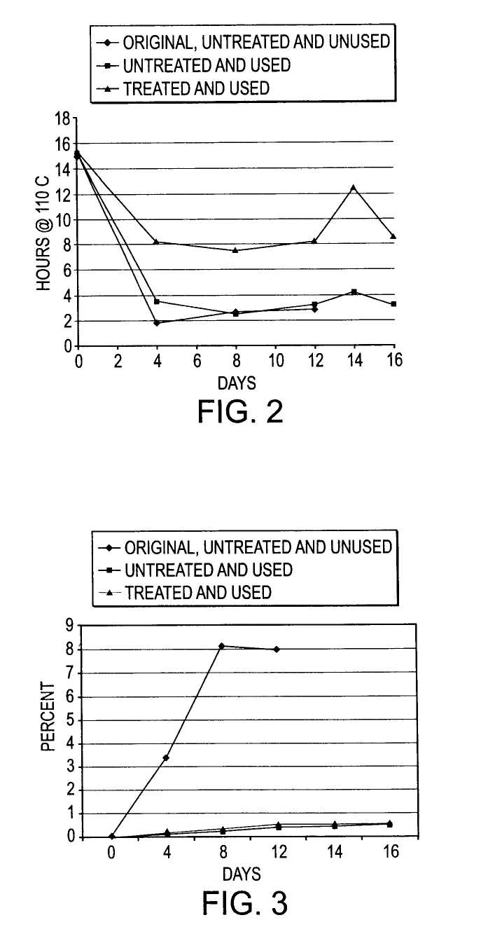

More specifically, FIG. 2 illustrates the changes in the oil stability index (OSI) for (i) the original, untreated and unused sample, (ii) the untreated and used sample, and (iii) the treated and used sample. FIG. 2 demonstrates that the used oil samples treated in accordance with the present invention exhibited significantly superior OSI values over the entire duration of testing, from 0 to 16 days.

FIG. 3 illustrates the percentage concentration of free fatty acids (FFA) for (i) the original, untreated and unused sample, (ii) the untreated and used sample, and (iii) the treated and used sample. FIG. 3 reveals that the used oil samples treated in accordance with the present invention, exhibited superior FFA values over nearly the entire period of testing.

### EXAMPLE III

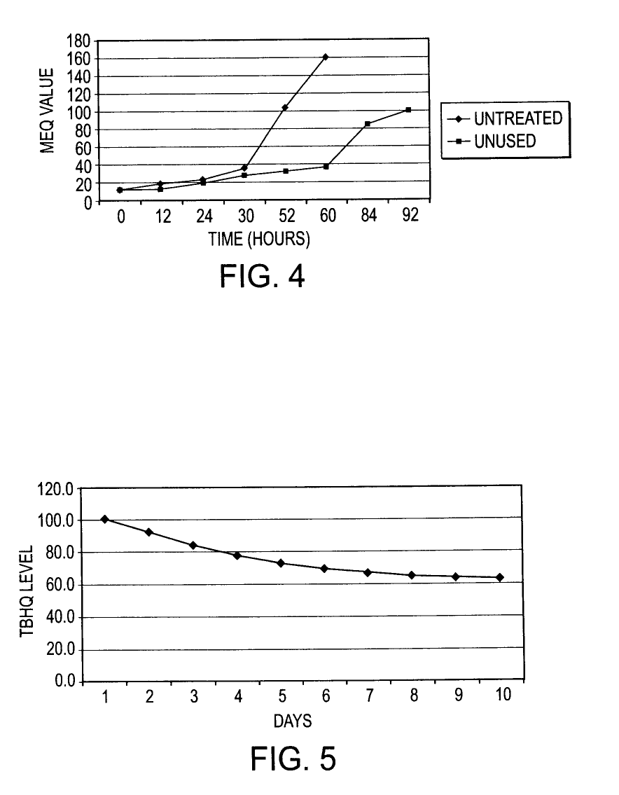

In another series of investigations, cooking medium samples, treated and untreated, were analyzed over a period of up to 92 hours. Specifically, the concentration of active oxygen, such as in peroxides and hydroperoxides, was assessed by determining the meq value. This method also known as the active oxygen method (AOM), predicts the stability of a fat by bubbling air through a solution of the fat using specific conditions of flow rate, temperature, and concentration. At intervals, peroxides and hydroperoxides produced by this treatment are determined by titration with iodine. The AOM value is defined as the number of hours required for the peroxide concentration to reach 100 meq/kg of fat. The more stable the fat, the longer it will take to reach that level. For products other than fats and oils, the fats must first be gently extracted with solvents. The method is very time-consuming since a stable fat may require 48 hours or more before reaching the required peroxide concentration. FIG. 4 is a graphical representation of this data and a comparison with an untreated sample. FIG. 4 illustrates that oil treated in accordance with the present invention exhibited significantly lower concentrations of active oxygen as compared to untreated samples, as indicated by the meq values. This observation was particularly pronounced after about 30 hours of use.

In the data illustrated in FIG. 4, the following procedures were undertaken.

A preferred embodiment product was evaluated as an additive to extend the life of frying oil. A bulk canola oil was used as the initial base oil. The oil used was Optima Clear Canola oil distributed by Magnifoods of Columbia, Md.

The “Untreated” was the oil noted above with no additives. The “Treated” was the base oil and 180 ppm of a preferred embodiment solid dosage product. Both samples were heated at 160° C.

The method used was the active oxygen method (AOM) which is accepted by the Association of Official Analytical Chemists (AOAC) as an oil stability method. As previously noted, this method utilizes an iodine titration to measure oxidative breakdown. The AOM is typically reported as number of hours for the sample to reach 100 meq/Kg of peroxide in the fat.

The untreated sample exceeded the 100 meq/Kg limit at 52 hours. The treated sample exceeded the 100 meq/Kg limit in 92 hours. This represents an 80% increase in the oil's useful life as measured by AOC.

### EXAMPLE IV

In yet another series of investigations, various types and grades of cooking medium, i.e. oils, were analyzed. Various samples of oil were obtained, several of which were treated according to the present invention. These samples were then subjected to the previously described tests in which AOM Stability, i.e. amount of active oxygen, was measured; the oil stability index (OSI) was measured; the percentage of free fatty acids was measured; and the concentration (in ppm) of TBHQ was measured. The samples included soybean oil, soybean oil that was heated, soybean oil containing various concentrations of TBHQ, and blended oil systems comprising soybean oil and corn oil, and TBHQ typically used in McDonald's franchises, the TBHQ being employed at various concentrations.

A summary of data collected from these investigations is set forth below in Table 5.

TABLE 5
Analyses of Various Oils

| | | Oil | | |
|---|---|---|---|---|
| | AOM | Stability | Free | |
| | Stability | Index | Fatty | TBHQ |
| Sample | meq/kg | Hours | Acids % | ppm |
| 1. Pure Soybean oil | 308.43 | 5.88 | 0.025 | N/A |
| 2. Pure Soybean oil* | 299.38 | 3.06 | 0.04 | N/A |
| 3. Soybean oil with TBHQ | 8.03 | 11.15 | 0.018 | 52 |
| 4. Soybean oil with TBHQ + | 6.43 | 17.56 | 0.044 | 287.3 |
| 200 ppm TBHQ | | | | |
| 5. Soybean oil with TBHQ + | 7.2 | 12.03 | 0.048 | 110 |
| 100 ppm TBHQ | | | | |
| 6. MCD (note 1) with TBHQ | 4 | 16.86 | 0.038 | 89.75 |
| 7. MCD with TBHQ (note 2) | 305.4 | 1.03 | 0.047 | <1 |
| 8. MCD with TBHQ + 100 | 51.08 | 8.33 | 0.046 | 35.8 |
| ppm TBHQ* | | | | |

Note 1
McDonald vegetable oil comprises soybean oil and corn oil and includes Citric Acid and TBHQ.
Note 2
Oil was heated up to 360° F. during 24 hours.

Regarding AOM stability and comparative levels of active oxygen in the oil samples, it is evident that generally, oil samples containing TBHQ exhibited significantly lower, and thus more stable, levels of active oxygen concentration as compared to samples not containing TBHQ. It is unknown why sample 7 (McDonald's oil with TBHQ, heated) exhibited such an extraordinary high level of active oxygen, as indicated by the elevated measurement of AOM. Within the set of samples containing TBHQ, it is apparent that generally, the higher the concentration of TBHQ, the lower the amount of active oxygen and thus, more stable was the oil sample. Concerning the oil stability index (OSI), generally, samples containing greater amounts of TBHQ exhibited increasingly beneficial properties, as indicated by high OSI values. And, free fatty acid (FFA) levels were generally consistent for all samples.

### EXAMPLE V

Another series of investigations were conducted in which a preferred embodiment ten-day oil replenishment cycle according to the present invention was analyzed. This cycle utilized the following parameters:

15% replacement in oil volume,

85% carry over day to day, and

10% reduction in TBHQ per day.

Table 6 displays data collected over this ten-day period. The data in Table 5 is expressed in percentages of the desired concentration of TBHQ in the oil system. Thus, for the data of Day 2, for example, two proportions are designated, a majority “Previous Volume” constituting 85% by volume of the oil system, and a minority “New addition” constituting 15% by volume of the oil system. At that time, the amount of TBHQ in the system decreased by 10%, and so, the amount of TBHQ, expressed as a percentage of the desired concentration, in the Previous Volume proportion, is 90%. The New Addition proportion contains the desired amount of TBHQ, and so, contains 100% of the desired concentration. The resulting amount of TBHQ, by segment, i.e. the Previous Volume and the New Addition proportions, expressed as percentages of the desired concentration of TBHQ are shown in the column in Table 5, “TBHQ by segment.” The next column in Table 6, is the resulting “TBHQ Contribution by Segment.” The Previous Volume proportion, containing 90% of the desired concentration of TBHQ, contributes 76.5% of the total amount of TBHQ in the oil system since the Previous Volume proportion constitutes 85% of the oil system. Similarly, the New Addition proportion, containing 100% of the desired concentration of TBHQ, contributes 15% of the total amount of TBHQ in the oil system. The sum of these two proportions, results in an amount of TBHQ that is 91.5% of the initial desired concentration of TBHQ.

As the preferred embodiment oil replenishment technique is repeated, as shown in Table 6, it can be seen that the resulting amounts of TBHQ in the oil system, although continuing to decrease, are approaching a steady-state value. Depending upon the various factors including the average amount of TBHQ reduction per day, a steady state concentration value of TBHQ will be approached.

TABLE 6
Preferred Embodiment Oil Replenishment Cycle

| | | | | TBHQ | Resulting |
|---|---|---|---|---|---|
| | | Vol. | TBHQ by | Contribution | TBHQ |
| | | Percent | segment | by Segment | Proportion |
| Day 1 | | 100 | | | 100.0 |
| Day 2 | Prev. Vol | 85 | 90.0 | 76.5 | |
| | (10% | | | | |
| | reduction) | | | | |
| | New addition | 15 | 100.0 | 15.0 | |
| | Weighted Avg. | | | | 91.5 |
| Day 3 | Prev. Vol | 85 | 91.5 | 68.6 | |
| | New addition | 15 | 100.0 | 15.0 | |
| | Weighted Avg. | | | | 83.6 |
| Day 4 | Prev. Vol | 85 | 83.6 | 62.7 | |
| | New addition | 15 | 100.0 | 15.0 | |
| | Weighted Avg. | | | | 77.7 |
| Day 5 | Prev. Vol | 85 | 77.7 | 58.3 | |
| | New addition | 15 | 100.0 | 15.0 | |
| | Weighted Avg. | | | | 73.3 |
| Day 6 | Prev. Vol | 85 | 73.3 | 55.0 | |
| | New addition | 15 | 100.0 | 15.0 | |
| | Weighted Avg. | | | | 70.0 |
| Day 7 | Prev. Vol | 85 | 70.0 | 52.5 | |
| | New addition | 15 | 100.0 | 15.0 | |
| | Weighted Avg. | | | | 67.5 |
| Day 8 | Prev. Vol | 85 | 67.5 | 50.6 | |
| | New addition | 15 | 100.0 | 15.0 | |
| | Weighted Avg. | | | | 65.6 |
| Day 9 | Prev. Vol | 85 | 65.6 | 49.2 | |
| | New addition | 15 | 100.0 | 15.0 | |
| | Weighted Avg. | | | | 64.2 |
| Day 10 | Prev. Vol | 85 | 64.2 | 48.2 | |
| | New addition | 15 | 100.0 | 15.0 | |
| | Weighted Avg. | | | | 63.2 |

This data in Table 6 is graphically represented in FIG. 5. It can be seen from FIG. 5 that a relatively constant concentration level of TBHQ is achieved by use of this preferred embodiment replacement technique. The relatively constant TBHQ level shown in FIG. 5 can be compared to the practice depicted in FIG. 1 that results in highly fluctuating concentrations of TBHQ.

Based upon this data, it is evident that significant cost savings can be achieved by use of the present invention products and methods. For example, based upon the following assumptions, a large commercial restaurant could be expected to realize cost savings of between $20 million and $66 million per year for North American operations, if 30% to 100% extension of the cooking medium was achieved. This data is summarized in Table 7. Total worldwide savings are also noted below in Table 7 using these same assumptions.

### Assumptions

(i) 6 vats per location, 50 lbs of oil per vat
(ii) Each vat “cycles” every 10 days, using 117.5 lbs/cycle, assume 15% daily replacement
(iii) Each vat uses 4230 lbs of oil/yr
(iv) Each location uses 25,380 lbs oil/yr
(v) Oil cost, $0.40/lb
(vi) 5 tablets/cycles/$2/tablet

TABLE 7
Estimated Cost Savings

| | Oil | # | Lbs | Oil cost/ | | Oil | |
|---|---|---|---|---|---|---|---|
| | Cost | Changes/ | used/ | yr/pot (inc. | # | cost/ | Savings/ |
| | ($lb) | yr/pot | y/pot | Ext. cost) | Pots | Loc. | location |
| Current | 0.40 | 36 | 4230 | 1,692 | 6 | 10,152 | |
| Extend Plus | | | | | | | |
| 30% extension | | | | | | 8,629 | 1523 |
| 60% extension | | | | | | 7,106 | 3046 |
| 100% extension | | | | | | 5,076 | 5076 |
| | | | | Total | | | |
| | # units | | N. Amer. | Worldwide | | | |
| | total | N. America | Oil Cost | Oil Cost | | | |
| McDonald's | 31,129 | 13.000 | 131,976,000 | 316,021,608 | | | |
| Savings Resulting | | | | Total | | | |
| from Preferred | | Life | N. Amer. | Worldwide | | | |
| Embodiment Product(s) | | extension | Savings | Savings | | | |
| | | 30% | 19,799,000 | 47,409,467 | | | |
| | | 60% | 39,598,000 | 94,818,934 | | | |
| | | 100% | 65,988,000 | 158,010,804 | | | |

All patents and publications referenced herein are incorporated by reference.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A tablet adapted to provide a controlled release of at least one antioxidant into a liquid oil-based system upon introduction of the tablet in the system, the tablet comprising:
an effective amount of at least one antioxidant selected from the group consisting of (I) tertiary butylhydroquinone, (II) propyl gallate, (III) butylated hydroxyanisole, (IV) butylated hydroxytoluene, and combinations of (I)-(IV);
a coating disposed about the at least one antioxidant, wherein the coating is exposed and in contact with the oil-based system upon introduction of the tablet in the system, the coating providing a controlled release of the at least one antioxidant such that all of the amount of the antioxidant is released over a time period of from about 0.5 hours to about 8 hours.

2. The tablet of claim 1 wherein all of the amount of antioxidant is released over a time period of from about 1 to about 6 hours.

3. The tablet of claim 1 wherein all of the antioxidant is released over a time period of from about 1.5 to about 3 hours.

4. The tablet of claim 1 wherein the rate of release is relatively constant.

5. The tablet of claim 1 wherein the rate of release varies from 10% to 500%.

6. The tablet of claim 1 wherein the rate of release varies from 20% to 400%.

7. The tablet of claim 1 wherein the rate of release varies from 50% to 200%.

8. The tablet of claim 1 wherein the coating comprises at least one oil, citric acid, and a monodiglyceride.

9. The tablet of claim 1 wherein the antioxidant is (I) tertiary butylhydroquinone.

10. The tablet of claim 1 further comprising citric acid and Vitamin K.

11. The tablet of claim 1 wherein the coating comprises glycerol monostearate.

12. The tablet of claim 1 wherein at least a portion of the antioxidant is microencapsulated by a secondary coating.

13. A method for introducing at least one antioxidant into a liquid oil-based system, the method comprising:
(i) providing an oil-based system comprising at least one antioxidant in a desired concentration;
(ii) forming a minority proportion and a majority proportion of the system, wherein the minority proportion constitutes from about 10% to about 20% of the total volume of the oil-based system;
(iii) replacing the minority proportion of the oil-based system with a new minority proportion that includes an equal amount of oil as the replaced minority proportion and the at least one antioxidant in the desired concentration;
(iv) after a time period of from about 4 to about 36 hours, repeating steps (ii)-(iii).

14. The method of claim 13 wherein the minority proportion constitutes from about 12% to about 18% of the total volume of the oil-based system.

15. The method of claim 13 wherein the minority proportion constitutes about 15% of the total volume of the oil-based system.

16. The method of claim 13 wherein the desired concentration of antioxidant is from about 200 ppm to about 50 ppm.

17. The method of claim 13 wherein the steps (ii)-(iii) are repeated 4 to 6 times.

18. The method of claim 13 wherein the time period in step (iv) is from about 6 to about 24 hours.
